(19) United States
(12) Patent Application Publication
(10) Pub. No.: US 2006/0007072 A1
(43) Pub. Date: Jan. 12, 2006

(54) Display device and driving method thereof

(75) Inventors: Beohm-Rock Choi, Seoul (KR); Jong-Moo Huh, Hwansung-gun (KR); Joon-Hoo Choi, Seoul (KR); Chun-Seok Ko, Hwansung-gun (KR); Cheol-Woo Park, Suwon-si (KR); Nam-Deog Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/137,145

(22) Filed: May 25, 2005

(30) Foreign Application Priority Data
Jun. 2, 2004 (KR) 2004-40005

(51) Int. Cl. G09G 3/30

(52) U.S. Cl. 345/76

(57) ABSTRACT

A display device is provided, including light emitting elements, first switching transistors transmitting data signals in response to scanning signals, second switching transistors transmitting a reverse bias voltage in response to a switching signal, capacitors charging voltages based on the data signals and discharging based on the reverse bias voltage; and driving transistors, each driving a transistor connected to a driving voltage and turning on and off in response to the voltage charged in the capacitor to connect and disconnect a signal passage from the driving voltage to the light emitting element.

### BACKGROUND OF THE INVENTION

(a) Field of the Invention

The present disclosure relates to display devices and driving methods, and more particularly relates to a light emitting display device and a driving method thereof.

(b) Description of Related Art

Recent trends in lighter-weight and thinner personal computers and televisions sets call for correspondingly lighter-weight and thinner display devices. In addition, flat panel displays satisfying such requirements are being substituted for conventional cathode ray tubes (CRT). The flat panel displays may include a liquid crystal display (LCD), field emission display (FED), organic light emitting display (OLED), plasma display panel (PDP), or the like.

Generally, an active matrix flat panel display includes a plurality of pixels arranged in a matrix and displays images by controlling the luminance of the pixels based on given luminance information. An OLED is a self-emissive display device that displays image by electrically exciting light-emitting organic material. It has low power consumption, wide viewing angle, and fast response time, thereby being advantageous for displaying motion images.

A pixel of an OLED includes a light emitting element and a driving thin film transistor (TFT). The light-emitting element emits light having an intensity depending on the current driven by the driving TFT, which in turn depends on the threshold voltage of the driving TFT and the voltage between the gate and source of the driving TFT.

The TFT includes polysilicon or amorphous silicon. A polysilicon TFT has several advantages, but it also has disadvantages such as the complexity of manufacturing polysilicon, thereby increasing the manufacturing cost. In addition, it is hard to make a large OLED employing polysilicon TFTs.

An amorphous silicon TFT is easily applicable to a large OLED and may be manufactured using fewer process steps than the polysilicon TFT. However, the threshold voltage of the amorphous silicon TFT shifts over time such that the current flowing in the light emitting element is non-uniform to degrade image quality.

### SUMMARY OF THE INVENTION

The present disclosure addresses the problems of conventional techniques. Preferred embodiments of the disclosure offer desirable advantages.

A display device embodiment is provided, which includes a plurality of light emitting elements; a plurality of first switching transistors transmitting data signals in response to scanning signals; a plurality of second switching transistors transmitting a reverse bias voltage in response to a switching signal; a plurality of capacitors charging voltages based on the data signals and discharging based on the reverse bias voltage; and a plurality of driving transistors, each driving transistor connected to a driving voltage and turning on and off in response to the voltage charged in the capacitor to connect and disconnect a signal passage from the driving voltage to the light emitting element.

The reverse bias voltage may be lower than 0V. The first switching transistors sequentially may turn on during a first period and simultaneously turn off during second and third periods, and the second switching transistors may turn off during the first and the second periods and may turn on during the third period. The driving voltage may be higher than a common voltage connected to the light emitting elements during the second period and the light emitting elements may simultaneously emit light during the second period. The driving voltage or the common voltage may have at least two different voltage levels.

The second switching transistors may simultaneously turn on after a predetermined time elapses from the light emission of the light emitting elements. The pixels may include a first pixel group and a second pixel group, a turn-on time of the first switching transistors of the second pixel group may be different from a turn-on time of the first switching transistors of the first pixel group, and a turn-on time of the second switching transistors of the second pixel group may be different from a turn-on time of the second switching transistors of the first pixel group. The turn-on time of the first switching transistors of the second pixel group and the turn-on time of the first switching transistor of the first pixel group may be successive.

The light emitting elements of the first pixel group and the light emitting elements of the second pixel group may emit light at a time at least in part. The pixels may further include a third pixel group, a turn-on time of the first switching transistors of the third pixel group is different from the turn-on times of the first switching transistors of the first and the second pixel groups, and a turn-on time of the second switching transistors of the third pixel group is different from the turn-on times of the second switching transistors of the first and the second pixel groups.

The display device may include first and second driving signal lines connected to the first and the second pixel groups, respectively, and transmitting the driving voltage, wherein the first driving signal lines are separated from the second signal lines. Each of the first and the second driving signal lines may include at least one stem extending in a direction and a plurality of first branches branched from the at least one stem and extending substantially parallel to each other.

Each of the first and the second driving signal lines may further include a plurality of second branches intersecting the first branches. The first and the second switching transistors and the driving transistor may include amorphous silicon. The first and the second switching transistors and the driving transistor may include n-channel thin film transistors.

The display device may further include a scanning driver generating the scanning signals; a data driver generating the data signals; and a driving voltage generator generating the driving voltage and the switching signal. The display device may further include a signal controller controlling the scanning driver, the data driver, and the driving voltage generator. The data signals may include voltage signals.

A method embodiment of driving a display device including first pixels is also provided, each of the first pixels including a first light emitting element and a first driving transistor supplying current to the first light emitting element, the method including sequentially writing first data signals to the first pixels; simultaneously emitting the first light emitting elements based on the written data signals after the writing of the first data signals for all the first pixels is finished; and simultaneously supplying a reverse bias to the first driving transistors, wherein the emission of the first light emitting elements is suppressed during the writing of the first data signals.

The suppression of the light emission of the first light emitting elements may include decreasing a magnitude of a voltage applied to the first light emitting elements through the first driving transistors. The display device may further include second pixels, each of the second pixel including a second light emitting element and a second driving transistor supplying current to the second light emitting element, and the method may further include sequentially writing second data signals to the second pixels; simultaneously emitting the second light emitting elements based on the written data signals after the writing of the second data signals for all the second pixels is finished; and simultaneously supplying a reverse bias to the second driving transistors, wherein the emission of the second light emitting elements are suppressed during the writing of the second data signals, and the writing of the second data signals starts after the writing of the first data signals.

The emission of the second light emitting elements may overlap the emission of the first light emitting elements at least in part. A duration of the writing of the first data signals may be substantially equal to a duration of the writing of the second data signals, and the writing of the second data signals may start immediately after the writing of the first data signals. The suppression of the light emission of the first and the second light emitting elements may include decreasing a magnitude of a voltage applied to the first and the second light emitting elements through the first and the second driving transistors.

### BRIEF DESCRIPTION OF THE DRAWINGS

The present disclosure will become more apparent by describing embodiments thereof in detail with reference to the accompanying drawings, in which:

FIG. 1 is a block diagram of an organic light emitting display (OLED) according to an embodiment of the present disclosure;

FIG. 2 is an equivalent circuit diagram of a pixel of an OLED according to an embodiment of the present disclosure;

FIG. 3 is a schematic diagram that illustrates the configuration of driving signal lines of OLED according to an embodiment of the present disclosure.

FIG. 4 is an exemplary sectional view of a light emitting element and a driving transistor of FIG. 2;

FIG. 5 is a schematic diagram of an organic light-emitting element according to an embodiment of the present disclosure;

FIG. 6 is a timing chart illustrating several signals for an OLED according to an embodiment of the present disclosure;

FIG. 7 is a graphical diagram that illustrates waveforms of the voltages at the terminals of the driving transistor of an OLED according to an embodiment of the present disclosure;

FIG. 8 is a timing diagram showing another example of the driving signals for an OLED according to an embodiment of the present disclosure;

FIGS. 9A-9C are schematic diagrams that illustrate the configurations of driving signal lines of OLED according to embodiments of the present disclosure;

FIGS. 10 and 11 are exemplary timing diagrams of the driving signals for the OLED shown in FIGS. 9A-9C;

FIGS. 12A and 12B are schematic diagrams that illustrate the configurations of driving signal lines of OLED according to embodiments of the present disclosure;

FIG. 13 is a timing diagram of the driving signals for the OLED shown in FIGS. 12A and 12B; and

FIG. 14 is a graphical diagram that illustrates emission time as a linear function of recovery time according to embodiments of the present disclosure.

### DETAILED DESCRIPTION OF PREFERRED EMBODIMENTS

The present invention now will be described more fully hereinafter with reference to the accompanying drawings, in which preferred embodiments of the disclosure are shown. In the drawings, the thickness of layers and regions may be exaggerated for clarity. Like reference numerals may refer to like elements throughout the drawings. It will be understood that when an element such as a layer, region or substrate is referred to as being “on” another element, it can be directly on the other element or intervening elements may also be present. In contrast, when an element is referred to as being “directly on” another element, there are no intervening elements present. Exemplary display devices and driving methods thereof according to embodiments of the present disclosure will be described with reference to the accompanying drawings.

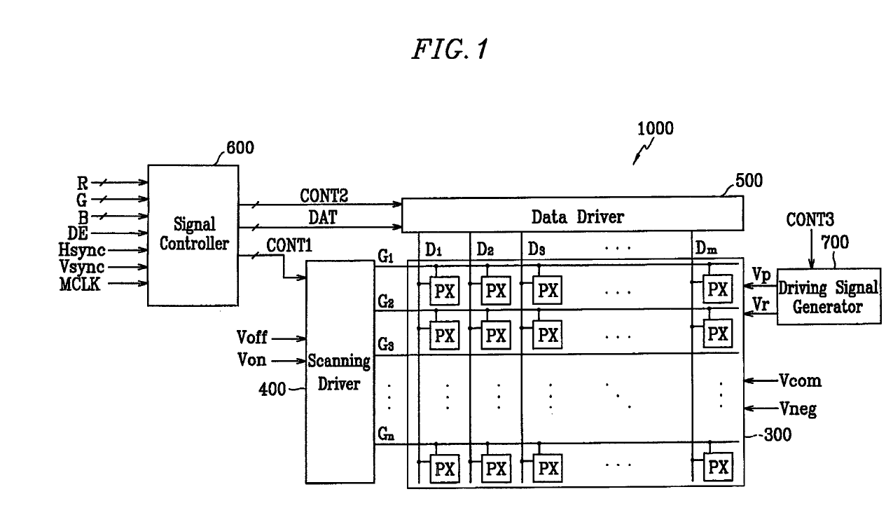

Referring to FIGS. 1-7, an organic light emitting display (OLED) according to an embodiment of the present disclosure will be described in detail.

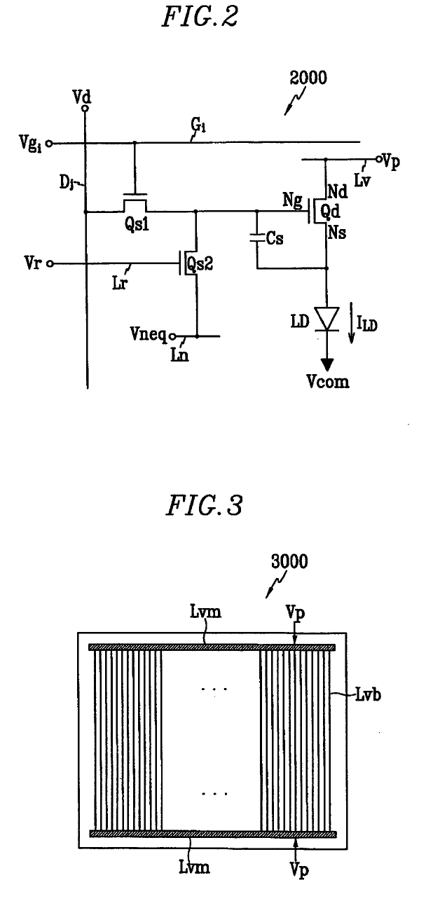

FIG. 1 is a block diagram of an OLED according to an exemplary embodiment of the present disclosure, FIG. 2 is an equivalent circuit diagram of a pixel of the OLED according to an exemplary embodiment of the present disclosure, and FIG. 3 schematically illustrates the configuration of driving signal lines of the OLED according to an exemplary embodiment of the present disclosure.

As shown in FIG. 1, an OLED according to an exemplary embodiment of the present disclosure is indicated generally by the reference numeral 1000. The OLED 1000 includes a display panel 300, three drivers including a scanning driver 400, a data driver 500, and a driving signal generator 700 that are connected to the display panel 300, and a signal controller 600 controlling the above elements.

Referring to FIG. 1, the display panel 300 includes a plurality of signal lines and a plurality of pixels PX connected thereto and arranged substantially in a matrix.

The signal lines include a plurality of scanning lines G1-Gn for transmitting scanning signals and a plurality of data lines D1-Dm for transmitting data signals. The scanning lines G1-Gn extend substantially in a row direction and substantially parallel to each other, while the data lines D1-Dm extend substantially in a column direction and substantially parallel to each other.

Turning to FIG. 2, an equivalent circuit diagram of a pixel of the OLED 1000 according to an exemplary embodiment of the present disclosure is indicated generally by the reference numeral 2000.

Turning now to FIG. 3, a configuration of driving signal lines of the OLED 1000 according to an exemplary embodiment of the present disclosure is indicated generally by the reference numeral 3000.

Referring to FIGS. 2 and 3, the signal lines further include driving voltage lines Lv for transmitting a driving voltage signal Vp, switching signal lines Lr for transmitting a switching signal Vr, and reverse bias lines Ln for transmitting a reverse bias voltage Vneg. The signal lines Lv, Lr, and Ln extend in the row direction or the column direction.

Referring to FIG. 3, the driving signal lines Lv include a pair of stems Lvm and a plurality of branches Lvb. The stems Lvm are disposed near upper and lower edges of the display panel 300 and extend substantially in the row direction. The branches Lvb connect the stems Lvm and extend substantially in the column direction. The driving voltage signal Vp is first applied to the stems Lvm and transmitted to the pixels PX through the branches Lvb.

The width of the stems Lvm is sized sufficient for supplying the currents consumed for all pixels to emit light, and sized larger than that of the branches Lvb. Alternatively, the stems Lvm may be disposed near left and right edges of the display panel 300 and extend substantially in the column direction, while the branches Lvb extend substantially in the row direction to connect the stems Lvm.

Referring to FIG. 2, each pixel PX, such as, for example, a pixel connected to a scanning line G1 and a data line Dj, includes an organic light emitting element LD, a driving transistor Qd, a capacitor Cs, and two switching transistors Qs1 and Qs2.

The driving transistor Qd has a control terminal Ng connected to the switching transistors Qs1 and Qs2, an input terminal Nd connected to a driving signal line Lv for transmitting the driving voltage signal Vp, and an output terminal Ns connected to the light emitting element LD.

The light-emitting element LD has an anode connected to the output terminal Ns of the driving transistor Qd and a cathode connected to a common voltage Vcom. The light emitting element LD emits light having an intensity depending on an output current ILD of the driving transistor Qd. The output current ILD of the driving transistor Qd depends on the voltage Vgs between the control terminal Ng and the output terminal Ns of the driving transistor Qd.

The switching transistor Qs1 has a control terminal connected to the scanning line G1, an input terminal connected to the data line Dj, and an output terminal connected to the control terminal Ng of the driving transistor Qd. The switching transistor Qs1 transmits the data signal Vd applied to the data line Dj to the driving transistor Qd in response to the scanning signal Vgi applied to the scanning line G1.

The switching transistor Qs2 has a control terminal connected to the switching signal line Lr, an input terminal connected to the reverse bias line Ln, and an output terminal connected to the control terminal Ng of the driving transistor Qd. The switching transistor Qs2 transmits the reverse bias voltage Vneg to the driving transistor Qd in response to the switching signal Vr.

The magnitude of the reverse bias voltage Vneg is determined so that a sufficiently high reverse bias is applied between the control terminal Ng and the output terminal Ns of the driving transistor Qd. The reverse bias voltage Vneg is preferably lower than about 0V, such as, for example, about −15V. The reverse bias voltage Vneg applied to the control terminal Ng of the driving transistor Qd can discharge the electrons trapped in a gate insulating layer of the driving transistor Qd during the light emission of the light-emitting element LD.

The switching transistors Qs1 and Qs2 and the driving transistor Qd are n-channel field effect transistors (FETs) including amorphous silicon or polysilicon. However, the transistors Qs1 and Qs2 and Qd may be p-channel FETs operating in a manner opposite to n-channel FETs.

The capacitor Cs is connected between the control terminal Ng and the output terminal Ns of the driving transistor Qd. The capacitor Cs stores and maintains the data signal Vd or the reverse bias voltage Vneg applied to the control terminal Ng of the driving transistor Qd.

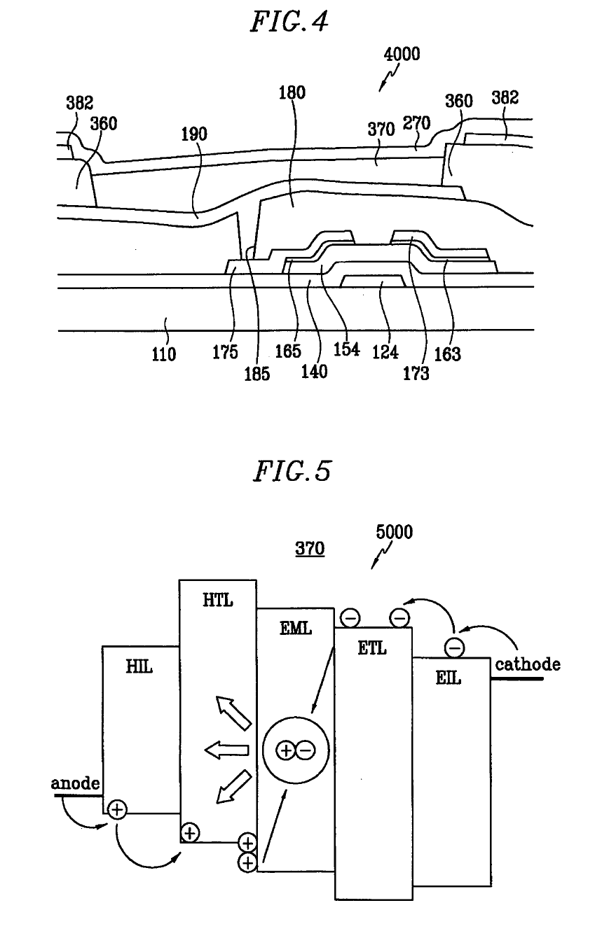

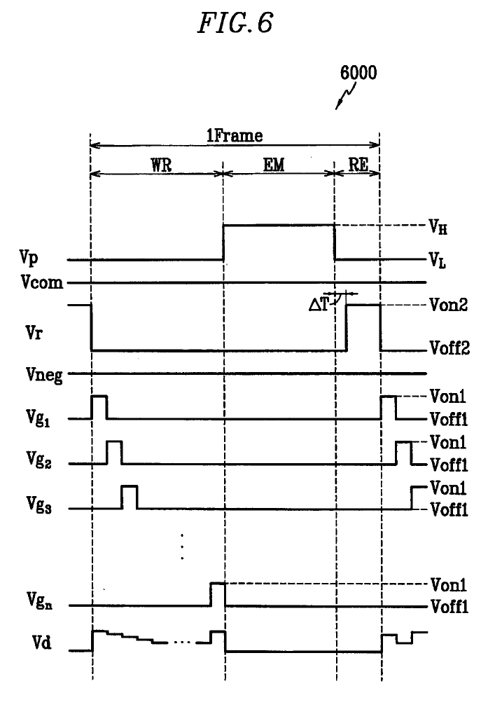

A structure of a light emitting element LD and a driving transistor Qd connected thereto as shown in FIG. 2 will be described in detail with reference to FIGS. 4 and 5.

As shown in FIG. 4, the light emitting element LD and the driving transistor Qd of FIG. 2 are indicated generally by the reference numeral 4000. FIG. 4 is an exemplary sectional view of a light-emitting element LD and a driving transistor Qd shown in FIG. 2.

Turning to FIG. 5, an organic light-emitting element according to an embodiment of the present disclosure is indicated generally by the reference numeral 5000.

A control electrode 124 is formed on an insulating substrate 110. The control electrode 124 is preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. The control electrode 124 may have a multi-layered structure including two films having different physical characteristics. One of the two films is preferably made of low resistivity metal including Al containing metal, Ag containing metal, and Cu containing metal for reducing signal delay or voltage drop. The other film is preferably made of material such as Mo containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, the gate electrode 124 may be made of various metals or conductors. The lateral sides of the gate electrode 124 are inclined relative to a surface of the substrate, and the inclination angle thereof ranges from about 30-80 degrees.

An insulating layer 140 preferably made of silicon nitride (SiNx) is formed on the control electrode 124. A semiconductor 154 preferably made of hydrogenated amorphous silicon (abbreviated to “a-Si”) or polysilicon is formed on the insulating layer 140, and a pair of ohmic contacts 163 and 165 preferably made of silicide or n+ hydrogenated a-Si heavily doped with n type impurity such as phosphorous are formed on the semiconductor 154. The lateral sides of the semiconductor 154 and the ohmic contacts 163 and 165 are inclined relative to the surface of the substrate, and the inclination angles thereof are preferably in a range of about 30-80 degrees.

An input electrode 173 and an output electrode 175 are formed on the ohmic contacts 163 and 165 and the insulating layer 140. The input electrode 173 and the output electrode 175 are preferably made of refractory metal such as Cr, Mo, Ti, Ta, or alloys thereof. However, they may have a multilayered structure including a refractory metal film and a low resistivity film. Good examples of the multi-layered structure are a double-layered structure including a lower Cr/Mo (alloy) film and an upper Al (alloy) film and a triple-layered of a lower Mo (alloy) film, an intermediate Al (alloy) film, and an upper Mo (alloy) film. Like the gate electrode 124, the input electrode 173 and the output electrode 175 have inclined edge profiles, and the inclination angles thereof range from about 30-80 degrees.

The input electrode 173 and the output electrode 175 are separated from each other and disposed opposite each other with respect to a gate electrode 124. The control electrode 124, the input electrode 173, and the output electrode 175 as well as the semiconductor 154 form a TFT serving as a driving transistor Qd having a channel located between the input electrode 173 and the output electrode 175.

The ohmic contacts 163 and 165 are interposed only between the underlying semiconductor stripes 151 and the overlying electrodes 173 and 175 thereon and reduce the contact resistance therebetween. The semiconductor 154 includes an exposed portion, which is not covered with the input electrode 173 and the output electrode 175.

A passivation layer 180 is formed on the electrode 173 and 175, the exposed portion of the semiconductor 154, and the insulating layer 140. The passivation layer 180 is preferably made of inorganic insulator such as silicon nitride or silicon oxide, organic insulator, or low dielectric insulating material. The low dielectric material preferably has dielectric constant lower than about 4.0 and examples thereof are a-Si:C:O and a-Si:O:F formed by plasma enhanced chemical vapor deposition (PECVD). The organic insulator may have photosensitivity and the passivation layer 180 may have a flat surface. The passivation layer 180 may be made of material having flatness characteristics and photosensitivity. The passivation layer 180 may have a double-layered structure including a lower inorganic film and an upper organic film so that it may take the advantage of the organic film as well as it may protect the exposed portions of the semiconductor 154. The passivation layer 180 has a contact hole 185 exposing a portion of the output electrode 175.

A pixel electrode 190 is formed on the passivation layer 180. The pixel electrode 190 is physically and electrically connected to the output terminal electrode 175 through the contact hole 185 and it is preferably made of transparent conductor such as ITO or IZO or reflective metal such as Ag or Al.

A partition 360 is formed on the passivation layer 180. The partition 360 encloses the pixel electrode 190 to define an opening on the pixel electrode 190 like a bank, and it is preferably made of organic or inorganic insulating material.

An organic light-emitting member 370 is formed on the pixel electrode 190 and it is confined in the opening enclosed by the partition 360.

Referring to FIG. 5, the organic light-emitting member 370 has a multilayered structure including an emitting layer EML and auxiliary layers for improving the efficiency of light emission of the emitting layer EML. The auxiliary layers include an electron transport layer ETL and a hole transport layer HTL for improving the balance of the electrons and holes and an electron injecting layer EIL and a hole injecting layer HIL for improving the injection of the electrons and holes. The auxiliary layers may be omitted.

An auxiliary electrode 382 having low resistivity such as Al (alloy) is formed on the partition 360.

A common electrode 270 supplied with a common voltage Vcom is formed on the organic light emitting member 370 and the partition 360. The common electrode 270 is preferably made of reflective metal such as Ca, Ba, Al or Ag, or transparent conductive material such as ITO or IZO.

The auxiliary electrode 382 contacts the common electrode 270 for compensating the conductivity of the common electrode 270 to prevent the distortion of the voltage of the common electrode 270.

A combination of opaque pixel electrodes 190 and a transparent common electrode 270 is employed to a top emission OLED that emits light toward the top of the display panel 300, and a combination of transparent pixel electrodes 190 and an opaque common electrode 270 is employed to a bottom emission OLED that emits light toward the bottom of the display panel 300.

A pixel electrode 190, an organic light emitting member 370, and a common electrode 270 form a light emitting element LD having the pixel electrode 190 as an anode and the common electrode 270 as a cathode or vice versa. The light emitting element LD uniquely emits one of the primary color lights depending on the material of the light-emitting member 380. An exemplary set of the primary colors includes red, green, and blue and the display of images is realized by the addition of the three primary colors.

Referring back to FIG. 1, the scanning driver 400 is connected to the scanning lines G1-Gn of the display panel 300 and synthesizes a gate-on voltage Von1 for turning on the switching transistors Qs1 and a gate-off voltage Voff1 for turning off the switching transistors Qs1 to generate scanning signals for application to the scanning lines G1-Gn.

The data driver 500 is connected to the data lines D1-Dm of the display panel 300 and applies data signals Vd to the data lines D1-Dm.

The scanning driver 400 or the data driver 500 may be implemented as an integrated circuit (IC) chip mounted on the display panel 300 or on a flexible printed circuit (FPC) film in a tape carrier package (TCP) type, which are attached to the display panel 300. Alternately, they may be integrated into the display panel 300 along with the signal lines G1-Gn and D1-Dm and the transistors Qd, Qs1 and Qs2.

The driving signal generator 700 is connected to the driving signal lines Lv of the display panel 300 and synthesizes a high voltage VH and the low voltage VL to generate the driving voltage signal Vp for application to the driving signal lines Lv. The high voltage VH is higher than the common voltage Vcom, and the low voltage VL is equal to or lower than the common voltage Vcom.

Furthermore, the driving signal generator 700 is also connected to the switching signal line Lr of the display panel 300 and synthesizes a gate-on voltage Von2 for turning on the switching transistor Qs2 and a gate-off voltage Voff2 for turning off the switching transistor Qs2 to generate the switching signal Vr, which is applied to the switching signal line Lr.

The signal controller 600 controls the scanning driver 400, the data driver 500, and the driving signal generator 700.

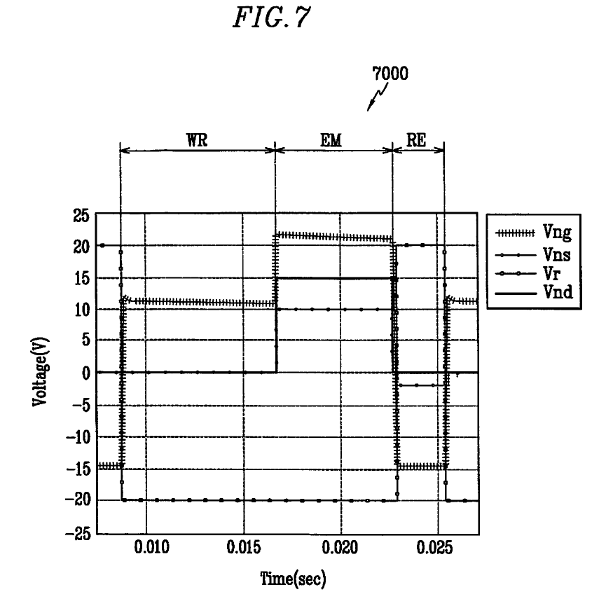

Now, the operation of the above-described OLED will be described in detail with reference to FIGS. 6 and 7.

Turning now to FIG. 6, a timing chart illustrating several signals for an OLED according to an embodiment of the present disclosure is indicated generally by the reference numeral 6000.

As shown in FIG. 7, waveforms of the voltages at the terminals of the driving transistor of an OLED according to an embodiment of the present disclosure are indicated generally by the reference numeral 7000.

The signal controller 600 is supplied with input image signals R, G and B and input control signals for controlling the display thereof such as a vertical synchronization signal Vsync, a horizontal synchronization signal Hsync, a main clock MCLK, and a data enable signal DE, from an external graphics controller. After generating scanning control signals CONT1, data control signals CONT2, and emission control signals CONT3 and processing the image signals R, G and B suitable for the operation of the display panel 300 on the basis of the input control signals and the input image signals R, G and B, the signal controller 600 sends the scanning control signals CONT1 to the scanning driver 400, the processed image signals DAT and the data control signals CONT2 to the data driver 500, and the emission control signals CONT3 to the driving signal generator 700.

The scanning control signals CONT1 include a scanning start signal STV for instructing to start scanning and at least one clock signal for controlling the output time of the gate-on voltage Von 1. The scanning control signals CONT1 may include a plurality of output enable signals for defining the duration of the gate-on voltage Von 1.

The data control signals CONT2 include a horizontal synchronization start signal STH for informing of start of data transmission for a group of pixels PX, a load signal LOAD for instructing to apply the data voltages to the data lines D1-Dm, and a data clock signal HCLK.

In response to the control signals CONT1-CONT3, the scanning driver 400, the data driver 500, and the driving signal generator 700 operate to apply signals to the display panel 300. The operations repeat every frame and one frame is divided into a writing period WR, an emission period EM, and a recovery period RE based on the characteristic of the operations.

The Writing Period (WR) is now described. First, the driving signal generator 700 changes the driving voltage signal Vp into the low voltage VL in response to the emission control signal CONT3 from the signal controller 600. The low voltage VL is preferably equal to or lower than the common voltage Vcom applied to the cathode of the light-emitting element LD. Hereinafter, it is assumed that the common voltage Vcom and the low voltage VL are equal to 0V. However, it is not limited to this exemplary case.

In addition, the driving signal generator 700 varies the switching signal Vr into the gate-off voltage Voff2. The gate-off voltage Voff2 is preferably lower than the reverse bias voltage Vneg to ensure the switching transistor Qs2 will be turned off, such as, for example, equal to about −20V. Then, the switching transistor Qs2 turns off to prevent the reverse bias voltage Vneg from being applied to the input terminal Ng of the driving transistor Qd.

In the meantime, the data driver 500 receives the image data for a group of pixels PX, such as, for example, the i-th pixel row from the signal controller 600, converts the image data into analog data voltages Vd, and applies the data signals Vd to the data lines D1-Dm in response to the data control signals CONT2 from the signal controller 600.

The scanning driver 400 makes a scanning signal Vgi for the i-th scanning signal line Gi equal to the gate-on voltage Von1 in response to the scanning control signals CONT1 from the signal controller 600, thereby turning on the switching transistors Qs1 connected to the i-th scanning signal line Gi. The data voltages Vd applied to the data lines D1-Dm are supplied to the control terminals Ng of the driving transistor Qd and the capacitors Cs through the switching transistors Qs1. The capacitors Cs charge the data voltages Vd.

By repeating this procedure by a unit of a horizontal period (which is denoted by “1H” and equal to one period of the horizontal synchronization signal Hsync and the data enable signal DE), all scanning lines G1-Gn are sequentially supplied with the gate-on voltage Von1 during the writing period WR, thereby applying the data voltages to all pixels.

Since the voltages stored in the capacitors Cs are maintained in the writing period WR even though the scanning signals Vg1-Vgn become the gate-off voltage Voff to turn off the switching transistors Qs1, the voltages Vng of the control terminals Ng of the driving transistors Qd are also remained.

However, since the driving voltage signal Vp is equal to or less than the common voltage Vcom in the writing period WR as described above, the voltage of the anode of the light emitting element LD is equal to or lower than the cathode thereof even if the driving transistor Qd turns on. Therefore, the light-emitting element LD does not flow a current ILD and thus the light-emitting element LD does not emit light.

As a result, in the writing period WR, the light-emitting element LD does not emit light although the data voltage Vd is written in each pixel. The Emission Period (EM) is now described. After the data voltages Vd are written in all pixels, the emission period starts when the driving signal generator 700 changes the driving voltage signal Vp into the high voltage VH in response to the emission control signal CONT3 from the signal controller 600. The high voltage VH is preferably equal to about 15V. The emission period EM may begin after a predetermined period elapses from the completion of the writing of the data voltages to the pixels.

When the voltage level of the driving voltage signal Vp increases, the voltage of the anode of the light-emitting element LD is higher than the voltage of the cathode thereof such that the current starts to flow. The magnitude of the current ILD depends on the voltage Vgs between the control terminal Ng and the output terminal Ns of the driving transistor Qd. The light-emitting element LD displays an image by emitting light having an intensity depending on the magnitude of the current ILD.

As shown in FIG. 7, as the input terminal voltage Vnd of the driving transistor Qd increases, while the control terminal voltage Vng and the output terminal voltage Vns of the driving transistor Qd also increase due to the bootstrapping by the capacitor Cs and the parasitic capacitances between the terminals of the driving transistor Qd. The output current ILD of the driving transistor Qd is determined by the voltage difference Vgs between the increased control terminal voltage Vng and the output terminal voltage Vns or the voltage stored in the capacitor Cs.

In the meantime, the switching signal Vr remains the gate-off voltage Voff2 to keep the switching transistor Qs2 in the off state in the emission period EM.

As a result, the light-emitting element LD does not emit light during the writing period WR but it emits light during the emission period EM, and the emission times of the light emitting elements LD can be equal to each other. The Recovery Period (RE) is now described. A recovery period begins when the driving signal generator 700 drops the driving voltage signal Vp down to the low voltage VL. Then, there is no current in the light-emitting element LD and the light-emitting element LD does not show the light emission. After a predetermined delay time ΔT elapses, the switching signal Vr is increased to the gate-on voltage Von2 that can turn on the switching transistor Qs2. The gate-on voltage Von2 is preferably higher than about 15V, more preferably about 20V, to ensure the turning on of the switching transistor Qs2.

When the switching transistor Qs2 turns on, the reverse bias voltage Vneg is applied to the control terminal Ng of the driving transistor Qd such that the capacitor Cs discharges the stored voltage and the driving transistor Qd turns off. This causes the discharge of the electrons trapped in a gate insulating layer of the driving transistor Qd during the emission period EM, and thus the shift of the threshold voltage Vth of the driving transistor Qd is reduced.

The delay time AT is determined to have a value that can recover the control terminal voltage Vng and the output terminal voltage Vns of the driving transistor Qd into that in the writing period WR after the driving voltage signal Vp becomes the low voltage VL in the recovery period RE. In this way, the voltage Vns between the control terminal Ng and the output terminal Ns of the driving transistor Qd is sufficiently large in magnitude with a negative polarity by the reverse bias voltage Vneg during the recovery period RE, and thus the shift of the threshold voltage Vth is further decreased.

However, the delay time ΔT may be set to be zero and the driving voltage signal Vp may maintain the low voltage VL in the recovery period RE.

The duration of the periods WR, EM and RE in one frame can be varied. For example, the period EM where the light-emitting element LD emits light is established to be equal to the periods WR and RE where the light-emitting element LD does not emit light. The recovery period RE is determined to reduce the degradation of the driving transistor Qd due to the reverse bias.

In the meantime, the mixture of the above-described two periods, i.e., a period with light emission and a period without light emission, serves the role of impulsive driving that can reduce the image drag of the motion images.

The driving voltage signal Vp, the switching signal Vr, and the reverse bias voltage Vneg may have various values other than the above-described values. In addition, one frame is divided into various numbers of periods, for example, two or more than three periods rather than the exemplary three periods. For example, the two period division may be realized by simultaneously performing the writing of the data and the light emission and thereafter, providing the reverse bias. An example of three or more periods is that each of the periods WR, EM and RE is divided into parts and the divided parts are inserted between the periods.

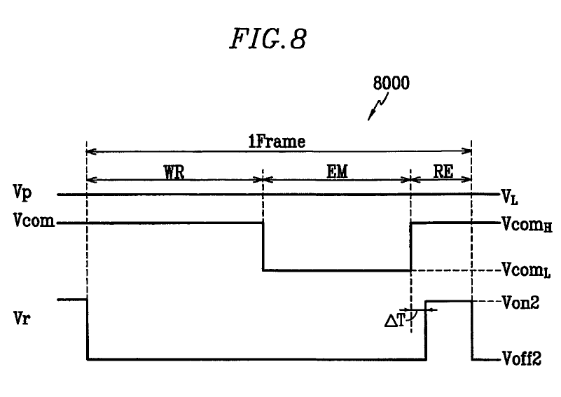

Turning to FIG. 8, a timing diagram showing another example of the driving signals for an OLED according to an embodiment of the present disclosure is indicated generally by the reference numeral 8000.

Referring to FIG. 8, the driving voltage signal Vp has a fixed value VL such as 0V and the common voltage Vcom has a varying voltage level. This may also yield the same display operations and the same advantages. That is, during the writing period WR, the common voltage Vcom has a value VcomH higher than the low voltage VL of the driving voltage signal Vp, such as, for example, about 0V, and this suppresses the light emission of the light emitting element LD and simultaneously writes the data voltage Vd to the control terminal Ng of the driving transistor Qd. During the emission period EM, the common voltage Vcom has a value VcomL sufficiently lower than the low voltage VL of the driving voltage signal Vp, such as, for example, about −15V for emitting the light emitting element LD. Finally, during the recovery period RE, the common voltage Vcom has the value VcomH again such that the light-emitting element LD does not emit light and the control terminal Ng of the driving transistor Qd is reversely biased.

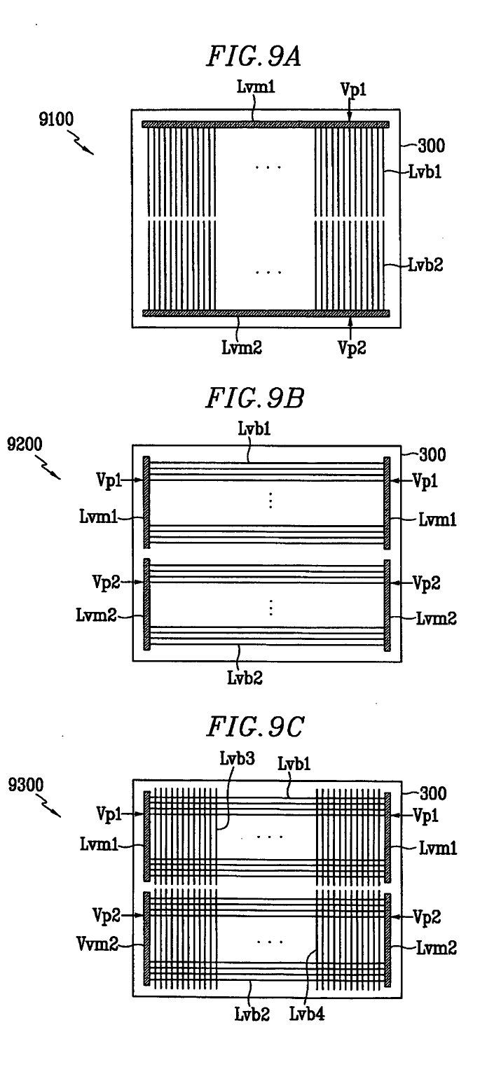

Next, a display device according to another embodiment of the present disclosure will be described in detail with reference to FIGS. 9A-11.

Turning now to FIGS. 9A-9C, configurations of driving signal lines of an OLED according to embodiments of the present disclosure are indicated generally by the reference numerals 9100, 9200 and 9300, respectively.

Referring to FIGS. 9A-9C, a display panel 300 of an OLED is divided into upper and lower blocks. Driving signal lines include upper driving signal lines disposed in the upper block and transmitting a driving voltage signal Vp1 and lower driving signal lines disposed in the lower block and transmitting another driving voltage signal Vp2.

The switching signal lines include upper and lower switching signal lines disposed in the upper and the lower blocks, respectively, and separated from each other. The data lines pass through both the upper and the lower blocks.

Referring to FIG. 9A, the upper driving signal lines include a stem Lvm1 disposed near an upper edge of the display panel 300, extending in the row direction, and supplied with a driving voltage signal Vp1 and a plurality of branches Lvb1 extending in the column direction from the stem Lvm1. The lower driving signal lines have a configuration symmetrical to the upper driving signal lines. That is, the lower driving signal lines include a stem Lvm2 disposed near a lower edge of the display panel 300, extending in the row direction, and supplied with the driving voltage signal Vp2 and a plurality of branches Lvb2 extending from the stem Lvm2 in the column direction. It is preferable that the stems Lvm1 and Lvm2 are wider than the branches Lvb1 and Lvb2.

Referring to FIG. 9B, each of the upper and the lower driving signal lines include a pair of stems Lvm1 or Lvm2 disposed near left and right edges of the display panel 300, extending in the column direction, and supplied with the driving voltage signal Vp1 or Vp2 and a plurality of branches Lvb1 or Lvb2 extending in the row direction from the stem Lvm1 or Lvm2. It is preferable that the stems Lvm1 and Lvm2 are wider than the branches Lvb1 and Lvb2.

Each of the upper and the lower driving signal lines shown in FIG. 9C include a plurality of longitudinal branches Lvb3 or Lvb4 as well as a pair of stems Lvm1 or Lvm2 and a plurality of transverse branches Lvb1 or Lvb2 shown in FIG. 9B. The longitudinal branches Lvb3 and Lvb4 intersect the transverse branches Lvb1 and Lvb2. This lattice pattern of the driving signal lines is advantageous for transmitting the driving voltage signals Vp1 and Vp2 to the respective pixels.

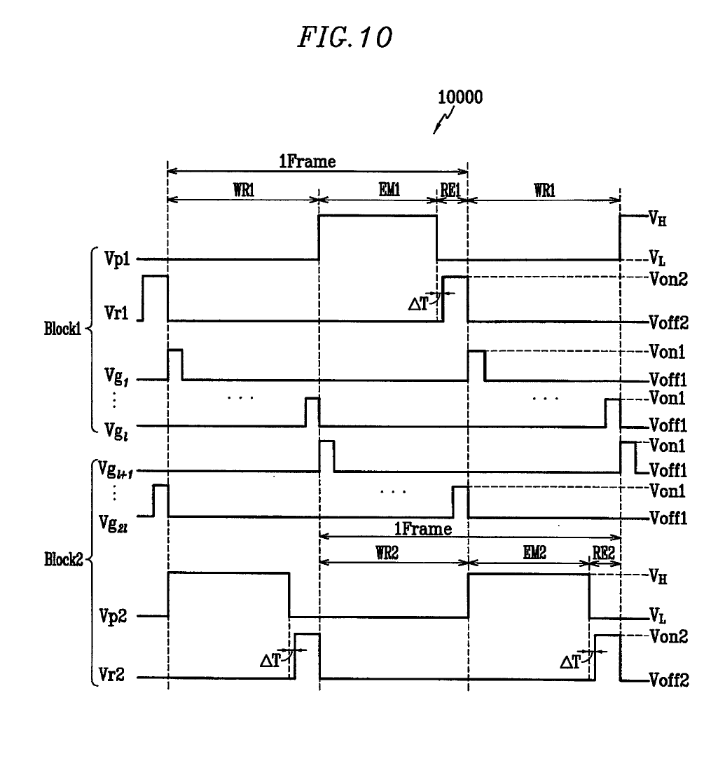

As shown in FIG. 10, a timing diagram of the driving signals for an OLED shown in FIGS. 9A-9C is indicated generally by the reference numeral 10000.

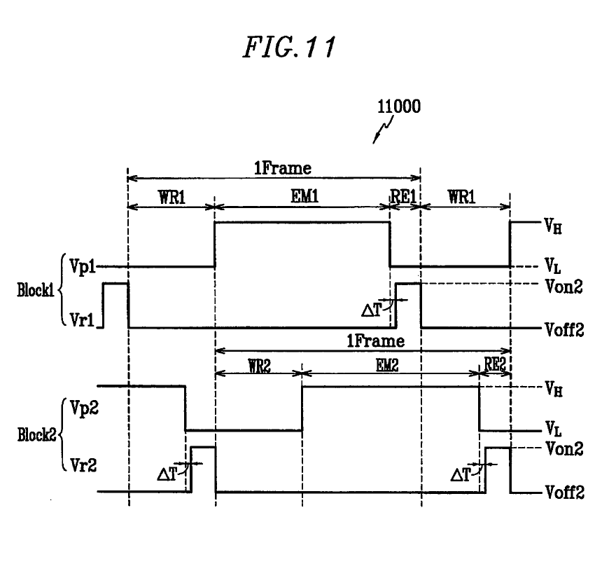

Turning to FIG. 11, another timing diagram of the driving signals for the OLED shown in FIGS. 9A-9C is indicated generally by the reference numeral 11000. The operation of the OLED shown in FIGS. 9A-9C will now be described in detail with reference to FIGS. 10 and 11.

Referring to FIGS. 10 and 11, the two blocks in this display device are operated in time difference. It is assumed that the upper block includes first to the l-th scanning lines, while the lower block includes the (l+1)th to the 2l-th scanning lines. The switching signal for the upper block is denoted by Vr1 and the switching signal for the lower block is denoted by Vr2. A writing period, an emission period, and a recovery period for the upper block are denoted by WR1, EM1, and RE1, respectively; and a writing period, an emission period, and a recovery period for the lower block are denoted by WR2, EM2, and RE2, respectively.

The writing period WR2 of the lower block begins after the writing period WR1 of the upper block finishes. In other words, the lower block operates in delay by the writing period WR1 of the upper block. The operations in each period for the upper and the lower blocks are substantially the same as those shown in FIGS. 1-8 and the detailed description thereof will be omitted.

Referring to FIG. 10, the duration of the writing period WR1 or WR2 is equal to a half frame and the writing period WR2 of the lower block starts at the time the writing period WR1 of the upper block finishes. This allows the pulse width of the scanning signals Vg1-Vg2I to be relatively enlarged and thus a time for charging data voltages Vd into the capacitors Cs can be increased. In addition, the emission period EM1 of the upper block and the emission period EM2 of the lower block do not overlap each other, thereby reducing a maximum current consumption.

Referring to FIG. 11, the duration of each of the writing periods WR1 and WR2 is shorter than a half frame. This allows the emission time of the light-emitting element LD to be increased since the emission period EM1 or EM2 are increased. Moreover, the recovery period RE1 or RE2 may be elongated. The writing periods WR1 and WR2 may not be successive.

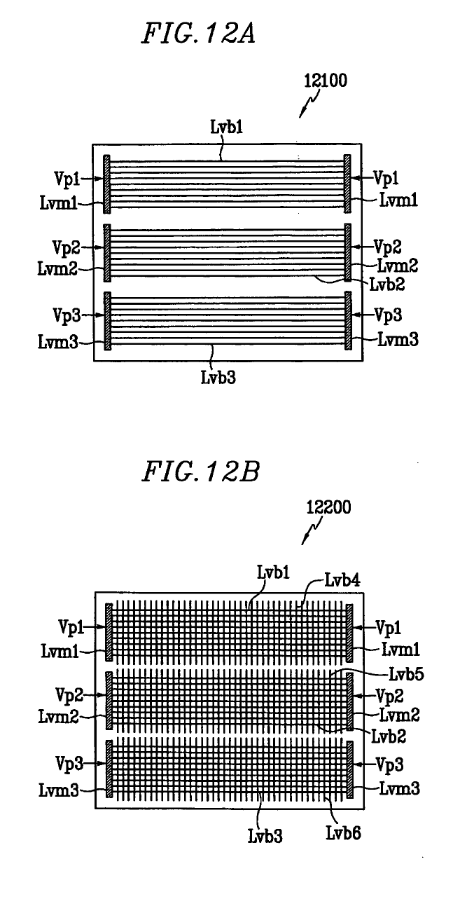

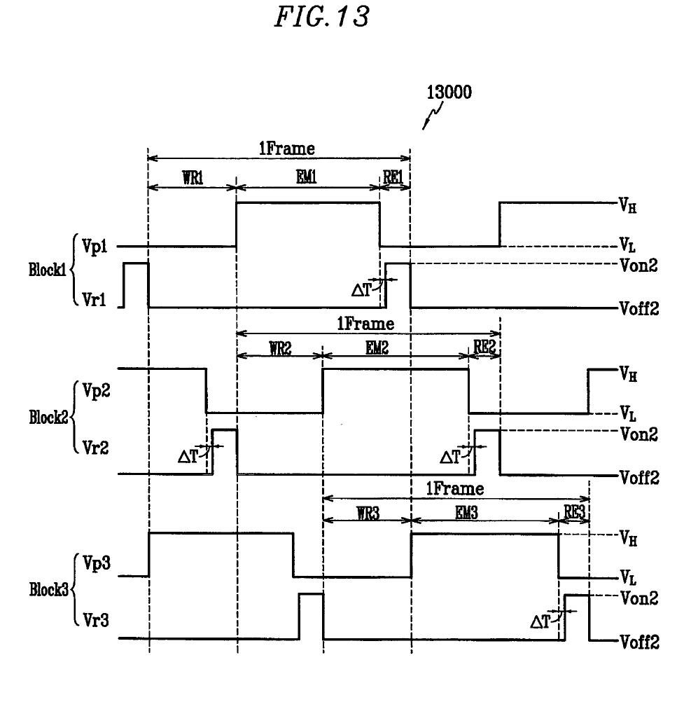

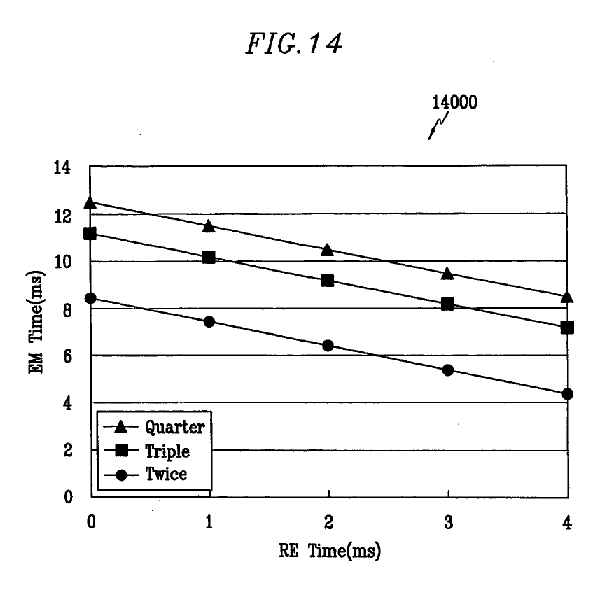

Next, a display device according to another embodiment of the present disclosure will be described in detail with reference to FIGS. 12A-13.

Turning now to FIGS. 12A and 12B, configurations of driving signal lines of OLEDs according to embodiments of the present disclosure are indicated generally by the reference numerals 12100 and 12200, respectively.

Referring to FIGS. 12A and 12B, a display panel 300 of an OLED is divided into first to third blocks arranged in a column direction. Driving signal lines include first driving signal lines disposed in the first block and transmitting a driving voltage signal Vp1, second driving signal lines disposed in the second block and transmitting another driving voltage signal Vp2, and third driving signal lines disposed in the third block and transmitting another driving voltage signal Vp3.

The switching signal lines include first to third switching signal lines disposed in the first to the third blocks, respectively, and separated from each other. The data lines pass through all the blocks.

Referring to FIG. 12A, each of the first to the third driving signal lines include a pair of stems Lvm1, Lvm2 or Lvm3 disposed near left and right edges of the display panel 300, extending in the column direction, and supplied with the driving voltage signal Vp1, Vp2 or Vp3, and a plurality of branches Lvb1, Lvb2 or Lvb3 extending in the row direction from the stem Lvm1, Lvm2 or Lvm3. It is preferable that the stems Lvm1-Lvm3 are wider than the branches Lvb1-Lvb3.

Each of the upper and the lower driving signal lines shown in FIG. 12B include a plurality of longitudinal branches Lvb4, Lvb5 or Lvb6 as well as a stems Lvm1, Lvm2 or Lvm3 and a plurality of transverse branches Lvb1, Lvb2 or Lvb3 shown in FIG. 12A. The longitudinal branches Lvb4, Lvb5 and Lvb6 intersect the transverse branches Lvb1, Lvb2 and Lvb3. This lattice pattern of the driving signal lines is advantageous for transmitting the driving voltage signals Vp1, Vp2 and Vp3 to the respective pixels.

Now, the operation of the OLED shown in FIGS. 12A and 12B will be described in detail with reference to FIG. 13.

As shown in FIG. 13, a timing diagram of the driving signals for the OLED shown in FIGS. 12A and 12B is indicated generally by the reference numeral 13000.

Referring to FIG. 13, the three blocks in this display device are operated in time difference. It is assumed that the first block includes first to the k-th scanning lines, the second block includes the (k+1)th to the 2k-th scanning lines, and the third block includes the (2k+1)th to the 3k-th scanning lines. The switching signal for the first block is denoted by Vr1, the switching signal for the second block is denoted by Vr2, and the switching signal for the third block is denoted by Vr3. A writing period, an emission period, and a recovery period for the first block are denoted by WR1, EM1, and RE1, respectively; a writing period, an emission period, and a recovery period for the second block are denoted by WR2, EM2, and RE2, respectively; and a writing period, an emission period, and a recovery period for the third block are denoted by WR3, EM3, and RE3, respectively.

The writing period WR2 of the second block begins after the writing period WR1 of the first block finishes, and the writing period WR3 of the third block begins after the writing period WR2 of the second block finishes. In other words, the second block operates in delay by the writing period WR1 of the first block and the third block operates in delay by the writing period WR2 of the second block. The operations in each period for the blocks are substantially the same as those shown in FIGS. 1-8 and the detailed description thereof will be omitted.

The duration of the writing period WR1, WR2 or WR3 is equal to about one third of a frame. The writing period WR2 of the second block starts at the time the writing period WR1 of the first block finishes and the writing period WR3 of the third block starts at the time the writing period WR2 of the second block finishes. This allows the pulse width of the scanning signals to be relatively enlarged and thus a time for charging data voltages Vd into the capacitors Cs can be increased. In addition, the emission periods EM1-EM3 do not overlap each other, thereby reducing a maximum current consumption.

Alternatively, the duration of each of the writing periods WR1 and WR2 is shorter than about ⅓ of a frame. This allows the emission time of the light-emitting element LD to be increased since the emission period EM1, EM2 or EM3 are increased. Moreover, the recovery period RE1, RE2 or RE3 may be elongated. The writing periods WR1, WR2 and WR3 may not be successive.

The display device may be divided into four or more blocks and the description thereof will be omitted since it is similar to those described above.

Turning to FIG. 14, a graph showing a relation between the emission time and the recovery time for various division numbers is indicated generally by the reference numeral 14000. An emission time, a writing time, and a recovery time mean the durations of the emission period, the writing period, and the recovery period, respectively.

Referring to FIG. 14, the emission time is a linear function of the recovery time with a negative gradient, and thus the emission time becomes short as the recovery time becomes long. A writing time for a divided block is equal to a frame divided by the number of blocks. For example, the writing time for each of the thrice-divided blocks is equal to one third of a frame. Therefore, the emission time and the recovery time of a frame block are equal to a half frame for twice division (for example, equal to 25/3 ms for a frame frequency of 60 Hz), equal to two thirds of a frame division for thrice division (for example, equal to 100/9 ms for a frame frequency of 60 Hz), and equal to three fourths of a frame for quarter division (for example, equal to 25/2 ms for a frame frequency of 60 Hz).

In order to reduce the shift of the threshold voltage Vth of the driving transistor Qd, the recovery time needs to be sufficient, but it reduces the emission time. However, the emission time increases for a given recovery time as the number of divisions increases. As a result, a desired recovery time and emission time can be realized by varying the number of divisions.

The present disclosure may also be applicable to a current programming type OLED that uses currents as data signals rather than voltages.

Although preferred embodiments of the present invention have been described in detail hereinabove, it shall be clearly understood that many variations and/or modifications of the basic inventive concepts herein taught may appear to those of ordinary skill in the pertinent art, and will still fall within the spirit and scope of the present invention, as defined in the appended claims.

What is claimed is:

1. A display device comprising:
a plurality of light emitting elements;
a plurality of first switching transistors transmitting data signals in response to scanning signals;
a plurality of second switching transistors transmitting a reverse bias voltage in response to a switching signal;
a plurality of capacitors charging voltages based on the data signals and discharging based on the reverse bias voltage; and
a plurality of driving transistors, each driving transistor connected to a driving voltage and turning on and off in response to the voltage charged in the capacitor to connect and disconnect a signal passage from the driving voltage to the light emitting element.

2. The display device of claim 1, wherein the reverse bias voltage is lower than 0V.

3. The display device of claim 1, wherein the first switching transistors sequentially turn on during a first period and simultaneously turn off during second and third periods, and the second switching transistors turn off during the first and the second periods and turn on during the third period.

4. The display device of claim 3, wherein the driving voltage is higher than a common voltage connected to the light emitting elements during the second period and the light emitting elements simultaneously emit light during the second period.

5. The display device of claim 4, wherein the driving voltage has at least two different voltage levels.

6. The display device of claim 4, wherein the common voltage has at least two different voltage levels.

7. The display device of claim 4, wherein the second switching transistors simultaneously turn on after a predetermined time elapses from the light emission of the light emitting elements.

8. The display device of claim 1, wherein the pixels comprise a first pixel group and a second pixel group, a turn-on time of the first switching transistors of the second pixel group is different from a turn-on time of the first switching transistors of the first pixel group, and a turn-on time of the second switching transistors of the second pixel group is different from a turn-on time of the second switching transistors of the first pixel group.

9. The display device of claim 8, wherein the turn-on time of the first switching transistors of the second pixel group and the turn-on time of the first switching transistors of the first pixel group are successive.

10. The display device of claim 8, wherein the light emitting elements of the first pixel group and the light emitting elements of the second pixel group emit light at least in part at the same time.

11. The display device of claim 8, wherein the pixels further comprise a third pixel group, a turn-on time of the first switching transistors of the third pixel group is different from the turn-on times of the first switching transistors of the first and the second pixel groups, and a turn-on time of the second switching transistors of the third pixel group is different from the turn-on times of the second switching transistors of the first and the second pixel groups.

12. The display device of claim 8, further comprising first and second driving signal lines connected to the first and the second pixel groups, respectively, and transmitting the driving voltage, wherein the first driving signal lines are separated from the second signal lines.

13. The display device of claim 12, wherein each of the first and the second driving signal lines comprises at least one stem extending in a direction and a plurality of first branches branched from the at least one stem and extending substantially parallel to each other.

14. The display device of claim 13, wherein each of the first and the second driving signal lines further comprises a plurality of second branches intersecting the first branches.

15. The display device of claim 1, wherein the first and the second switching transistors and the driving transistors comprise amorphous silicon.

16. The display device of claim 1, wherein the first and the second switching transistors and the driving transistors comprise n-channel thin film transistors.

17. The display device of claim 1, further comprising:
a scanning driver generating the scanning signals;
a data driver generating the data signals; and
a driving voltage generator generating the driving voltage and the switching signal.

18. The display device of claim 17, further comprising a signal controller controlling the scanning driver, the data driver, and the driving voltage generator.

19. The display device of claim 17, wherein the data signals comprise voltage signals.

20. A method of driving a display device including first pixels, each of the first pixels including a first light emitting element and a first driving transistor supplying current to the first light emitting element, the method comprising:
sequentially writing first data signals to the first pixels;
simultaneously emitting light from the first light emitting elements based on the written data signals after the writing of the first data signals for all of the first pixels is finished; and
simultaneously supplying a reverse bias to the first driving transistors,
wherein the emission of light from the first light emitting elements is suppressed during the writing of the first data signals.

21. The method of claim 20, wherein the suppression of the light emission of the first light emitting elements comprises:
decreasing a magnitude of a voltage applied to the first light emitting elements through the first driving transistors.

22. The method of claim 20, wherein the display device further comprises second pixels, each of the second pixels including a second light emitting element and a second driving transistor supplying current to the second light emitting element, the method further comprising:
sequentially writing second data signals to the second pixels;
simultaneously emitting light from the second light emitting elements based on the written data signals after the writing of the second data signals for all of the second pixels is finished; and
simultaneously supplying a reverse bias to the second driving transistors,
wherein the emission of light from the second light emitting elements is suppressed during the writing of the second data signals, and the writing of the second data signals starts after the writing of the first data signals.

23. The method of claim 22, wherein the emission of light from the second light emitting elements overlaps the emission of light from the first light emitting elements, at least in part.

24. The method of claim 22, wherein a duration of the writing of the first data signals is substantially equal to a duration of the writing of the second data signals, and the writing of the second data signals starts immediately after the writing of the first data signals.

25. The method of claim 22, wherein the suppression of the light emission of the first and the second light emitting elements comprises:
decreasing a magnitude of a voltage applied to the first and the second light emitting elements through the first and the second driving transistors.
